(19) United States
(12) Patent Application Publication
(10) Pub. No.: US 2002/0082988 A1
(43) Pub. Date: Jun. 27, 2002

(54) Server device for evaluating quality of service, service providing method and medium

(76) Inventors: Kazuyuki Ujiie, Kawasaki (JP); Hisashi Kawashima, Kawasaki (JP)

Correspondence Address: STAAS & HALSEY LLP, 700 11TH STREET, NW, SUITE 500, WASHINGTON, DC, 20001, US

(21) Appl. No.: 09/883,243

(22) Filed: Jun. 19, 2001

(30) Foreign Application Priority Data
Dec. 27, 2000 (JP) 2000-398966

(51) Int. Cl. G06F 17/60

(52) U.S. Cl. 705/39; 705/26

(57) ABSTRACT

A technology of the present invention takes not a method of determining a usage fee by a conventional charge-by-quantity system of an ASP (Application Service Provider) but a method of reflecting an evaluation of a quality of provided service in a fee calculation. A server device (1) of the present invention comprises a communication module (8) for performing communications with a client device (21, 21A, 21B), a service providing module (2) for providing a service to the client device via the communication module, an evaluation module (2) for evaluating a quality of the service provided, and a fee calculation module (13) for calculating a fee charged for the service in a way that reflects a result of the evaluation in the calculation.

### BACKGROUND OF THE INVENTION

The present invention relates to a technology of providing an application service.

In a service business in the sector of ASP (Application Service Provider) using a network, a customer (service user) pays a usage fee based mainly on a charge-by-quantity system. In this case, the customer pays the fee calculated based on a using time, a used disk capacity and a used memory capacity in the case of receiving an application service.

There arise, however, the following problems inherent in the prior art system.

First, the conventional system is incapable of reflecting, in calculating a fee, a degree of attainment or satisfaction of the service when using the application service.

Second, as viewed on the service provider side, there is no system for providing other customers with pieces of information on the service used by the customer concerned as a know-how case.

Therefore, the service provider is unable to neither ensure a repeatability of the customer nor accumulate the information for enhancing the quality of service.

### SUMMARY OF THE INVENTION

It is a primary object of the present invention, which was devised to obviate the problems inherent in the prior art described above, to provide a technology that takes not a method of determining a usage fee by a conventional charge-by-quantity system of an ASP but a method of reflecting an evaluation of a quality of provided service in calculating a fee for the service used.

It is another object of the present invention to provide a technology capable of accumulating, as a know-how case, contents of the service used by the user and various pieces of data used for the user to receive the service on a service provider side.

To accomplish the above objects, according to one aspect of the present invention, a server device (1) comprises a communication module (8) for performing communications with a client device (21, 21A, 21B), a service providing module (2) for providing a service to the client device via the communication module, an evaluation module (2) for evaluating a quality of the service provided, and a fee calculation module (13) for calculating a fee charged for the service in a way that reflects a result of the evaluation in the calculation.

Preferably, the evaluation module (2) may evaluate the quality of the service on the basis of a degree of attainment of the service requested from the client device (21, 21A, 21B) Preferably, the communication module (8) may receive information on a degree of satisfaction of a customer which is evaluated by the client device (21, 21A, 21B) with respect to the service provided, and the evaluation module (2) may evaluate the quality of the service on the basis of the degree of satisfaction of the customer.

Preferably, the server device (1) may further comprise a recording module (4, 11) for recording a history of accesses to the server device (1) from the client device (21, 21A, 21B), and a count module (2) for counting a setting operation time when making a request for the service via the client device (21, 21A, 21B). The evaluation module (2) may estimate a degree of satisfaction of the customer with respect to the service from the history of the accesses, the setting operation time counted or the degree of attainment of the service in response to the request given from the client device (21, 21A, 21B).

According to another aspect of the present invention comprises a communication module (8) for performing communications with a client device (21, 21A, 21B), a service providing module for providing a service to the client device (21, 21A, 21B) via the communication module (8), and a usage knowledge accumulation module (4, 11) for accumulating pieces of usage knowledge for using the service, wherein the service providing module (2), when completing the service for the client device (21, 21A, 21B), makes a request for an approval for accumulating pieces of information on the service as the usage knowledge in the usage knowledge accumulation module (4, 11), and the usage knowledge accumulation module (4, 11), if obtaining the approval from the client device, accumulates the information on the service, and provides the client device (21, 21A, 21B) or other client device (21, 21A, 21B) with the information.

Preferably, the server device according may further comprise a fee calculation module (13) for calculating a fee charged for the service provided. The fee calculation module (13) may discount the fee charged for the service when obtaining the approval.

Preferably, the information on the service may be information on an execution case of executing an application program provided in the service, information on a definition of a macro process having a combination of a plurality of functions provided in the application program, or data generated by executing the application program.

According to a further aspect of the present invention, a service providing method of providing a service to a client device connected to a network, comprises a step (S10, S13) of receiving a request from the client device (21, 21A, 21B), a step (S14) of providing the service corresponding to the request, a step (S15) of evaluating a quality of the service provided, and a step (S18) of calculating a fee charged for the service in a way that reflects a result of the evaluation in the calculation.

According to a still further aspect of the present invention, there is provided a readable-by-computer recording medium recorded with a program, for providing any one of the functions described above, executed by a computer.

As discussed above, according to the present invention, there is taken not the method of determining the usage fee by the conventional charge-by-quantity system of the ASP but the method of reflecting the evaluation of the quality of provided service in the fee calculation.

Further, according to the present invention, the contents of the service used by the user and the various pieces of data used when the user receives the service, are accumulated as the know-how cases on the service provider side, and the users can share these know-how cases.

### BRIEF DESCRIPTION OF THE DRAWINGS

FIG. 1 is a diagram showing a basic architecture of an information processing system in an embodiment of the present invention;

FIG. 2 is a diagram showing an example of flows of a service and of money in the information processing system;

FIG. 3 is a diagram showing an example of carrying out a data conversion serve in the information processing system;

FIG. 4 is a diagram showing a procedure of referring to cases in the example of carrying out the data conversion service;

FIG. 5 is a diagram showing a hardware architecture of a server 1;

FIG. 6 is a flowchart showing a processing flow of the CAD data conversion service on the side of a user terminal 21;

FIG. 7 is a chart showing a display example of a charge system displayed on the user terminal 21 from the server 1;

FIG. 8 is a flowchart showing a processing flow of the CAD data conversion service by the server 1;

FIG. 9 is a flowchart showing a flow of calculating a fee charged in the server 1;

FIG. 10 is a flowchart showing a processing flow 1 of evaluating a degree of satisfaction;

FIG. 11 is a chart showing an example of registering an execution case in the user terminal 21;

FIG. 12 is a chart showing an example of searching the cases in the user terminal 21;

FIG. 13 is a flowchart showing a processing flow 2 of evaluating the degree of satisfaction; and

FIG. 14 is a chart showing an example of a macro command in a CAD.

### DETAILED DESCRIPTION OF THE PREFERRED EMBODIMENT

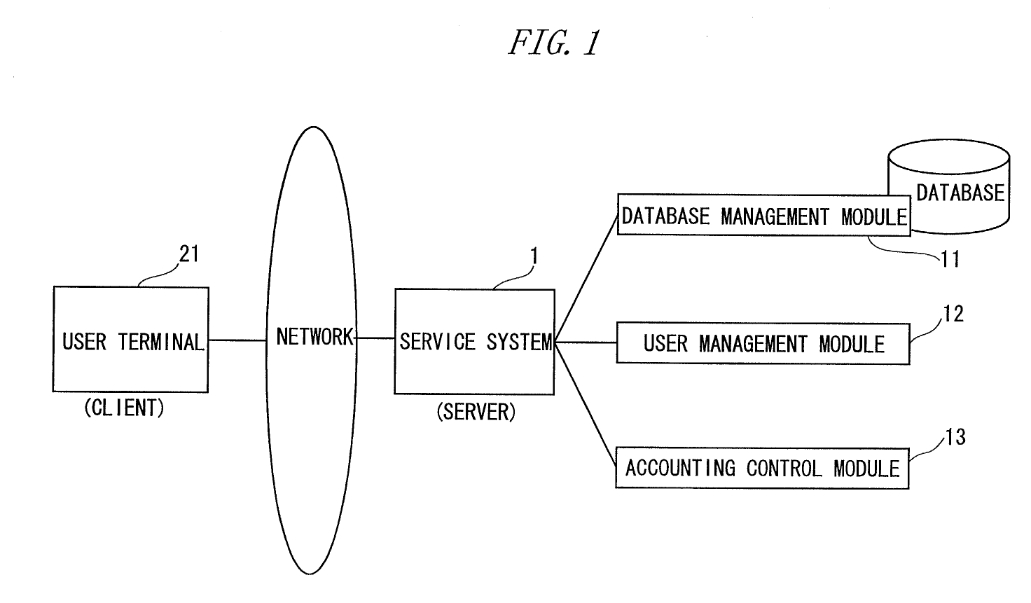

An embodiment of the present invention will hereinafter be described with reference to FIGS. 1 through 14.

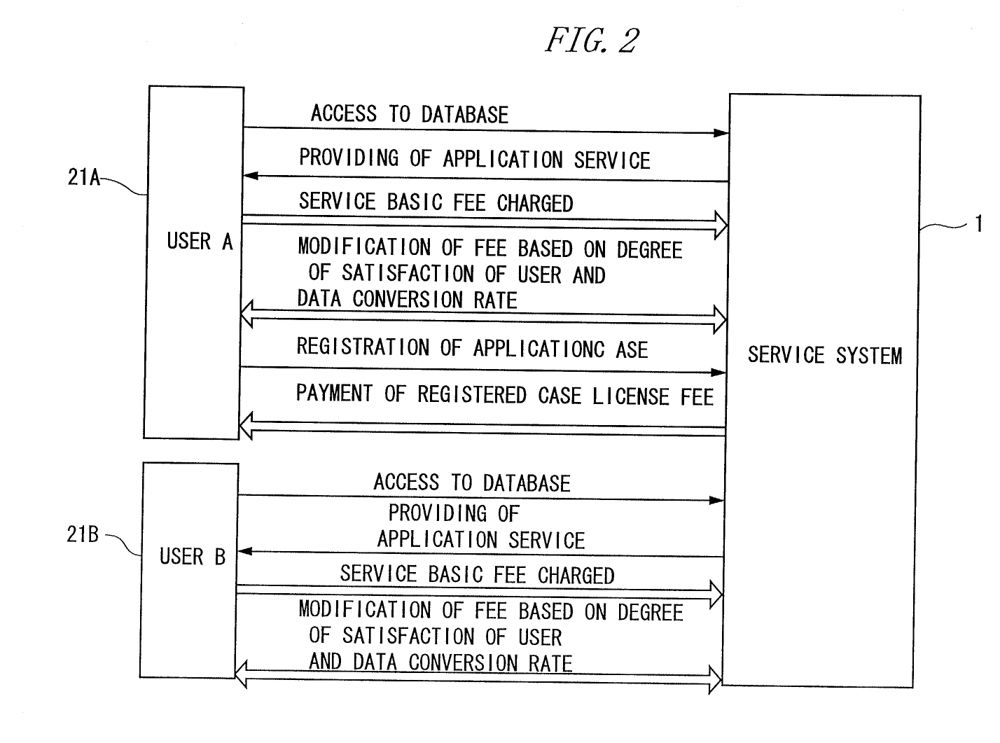

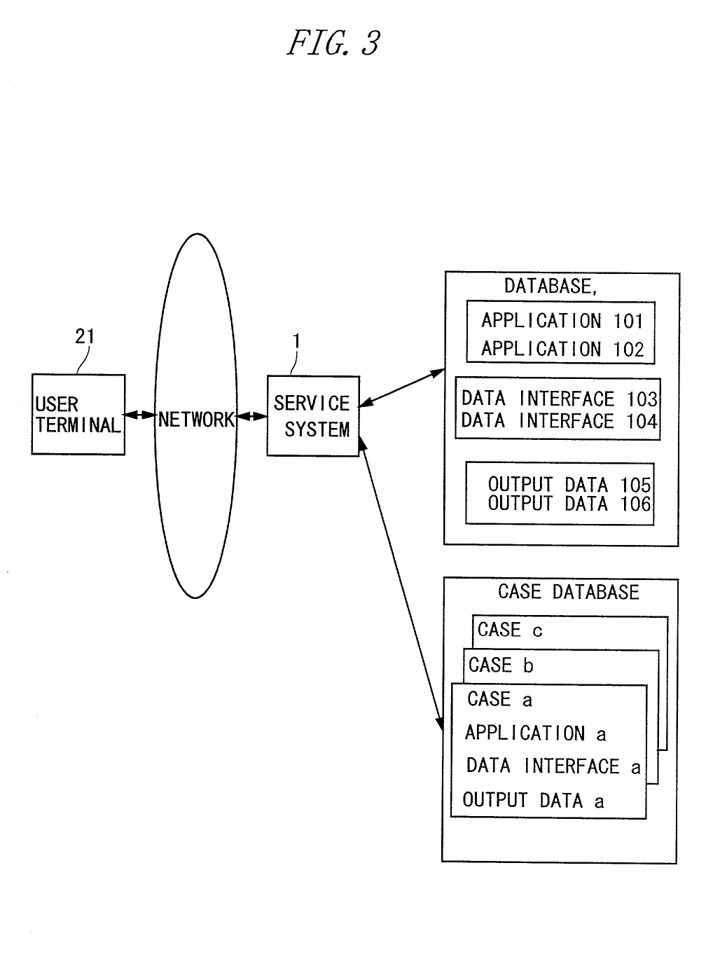

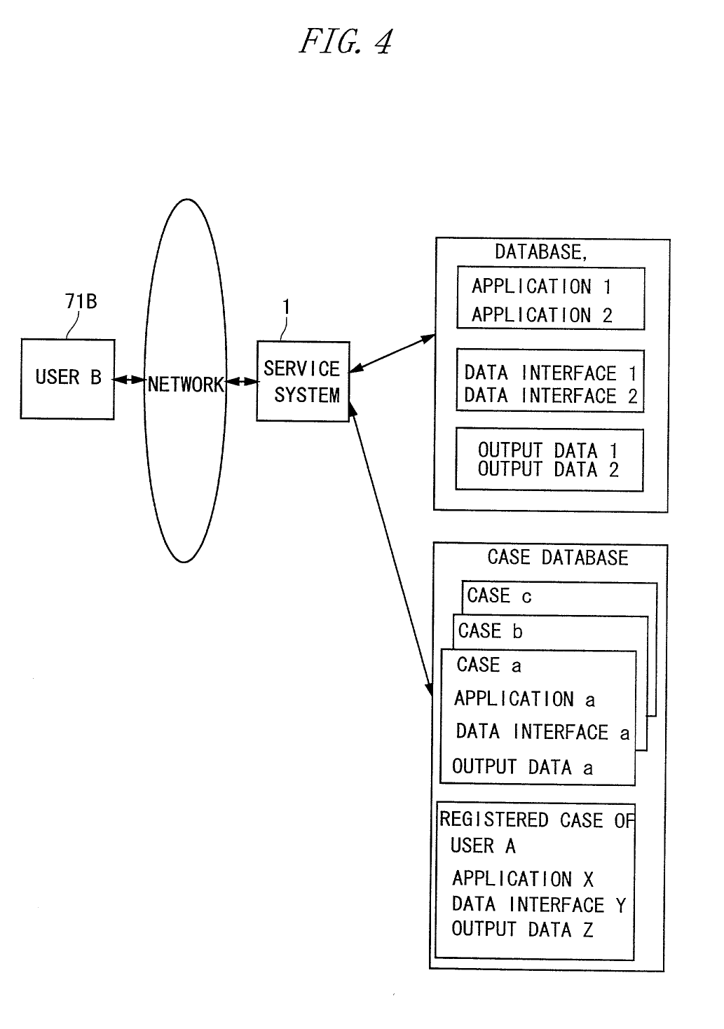

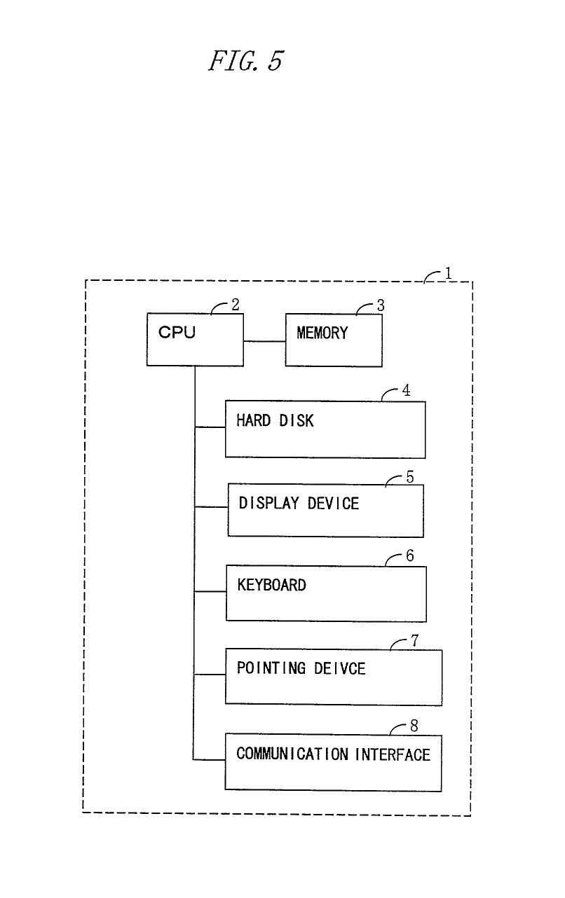

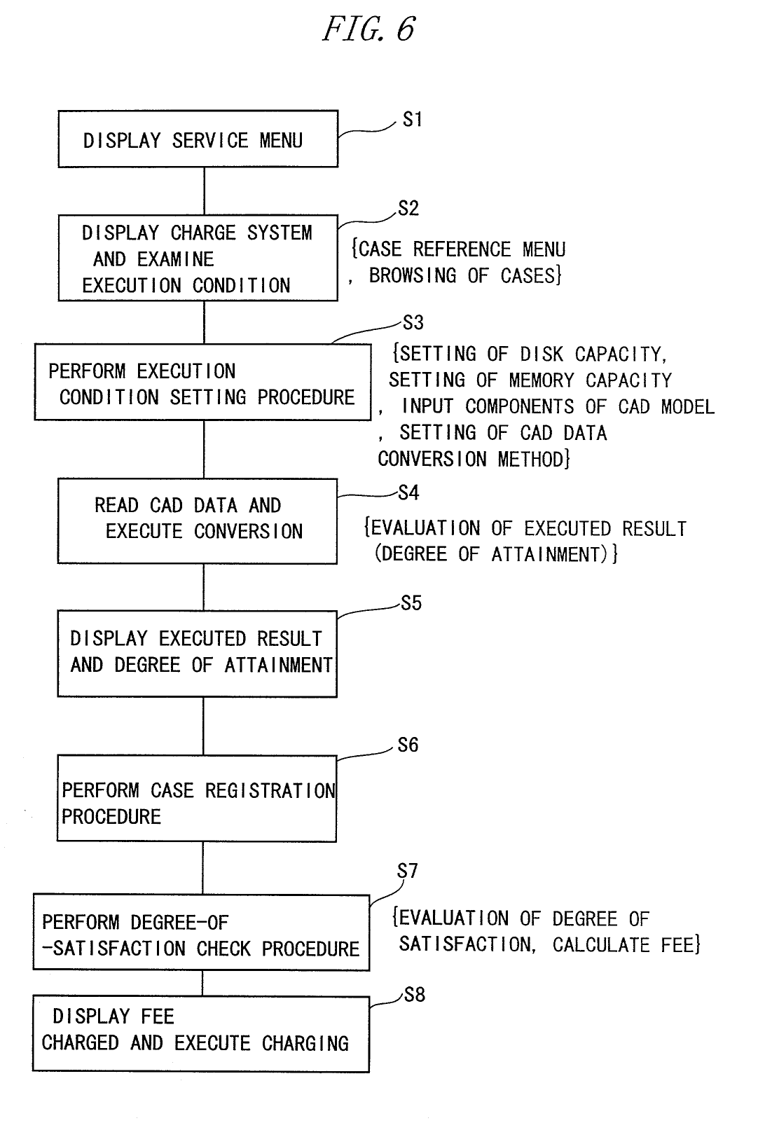

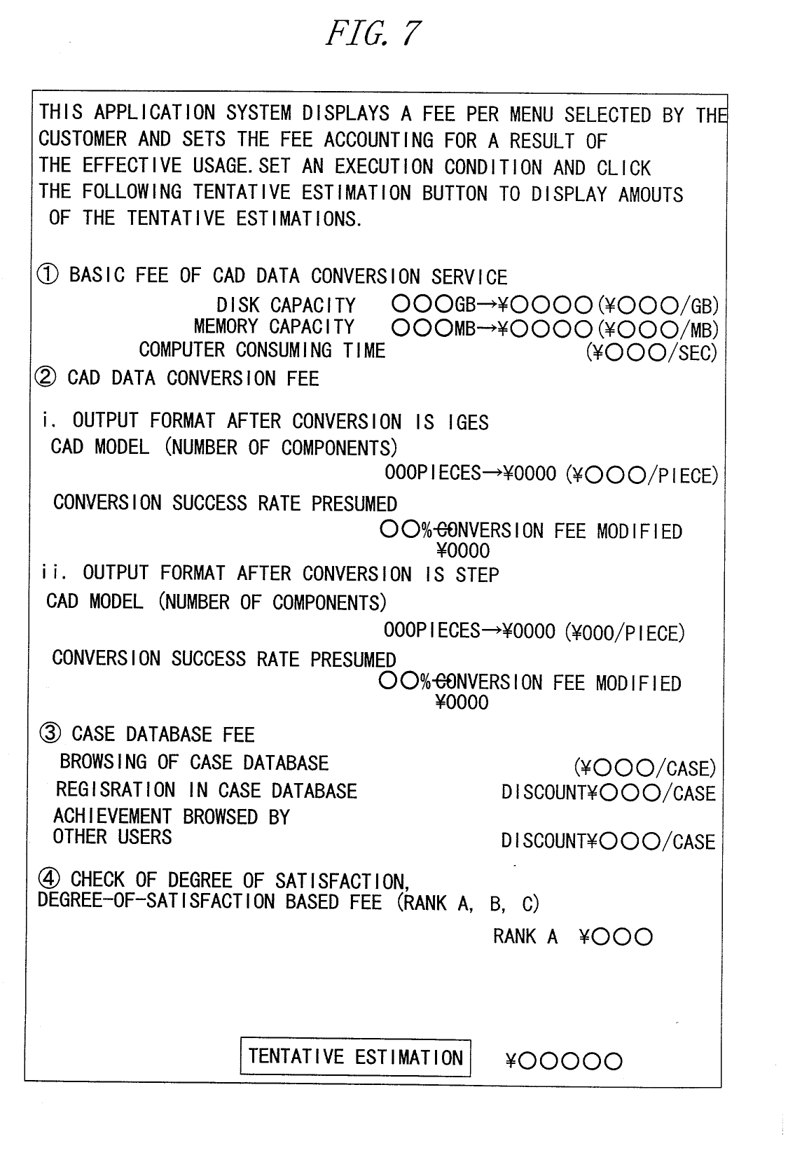

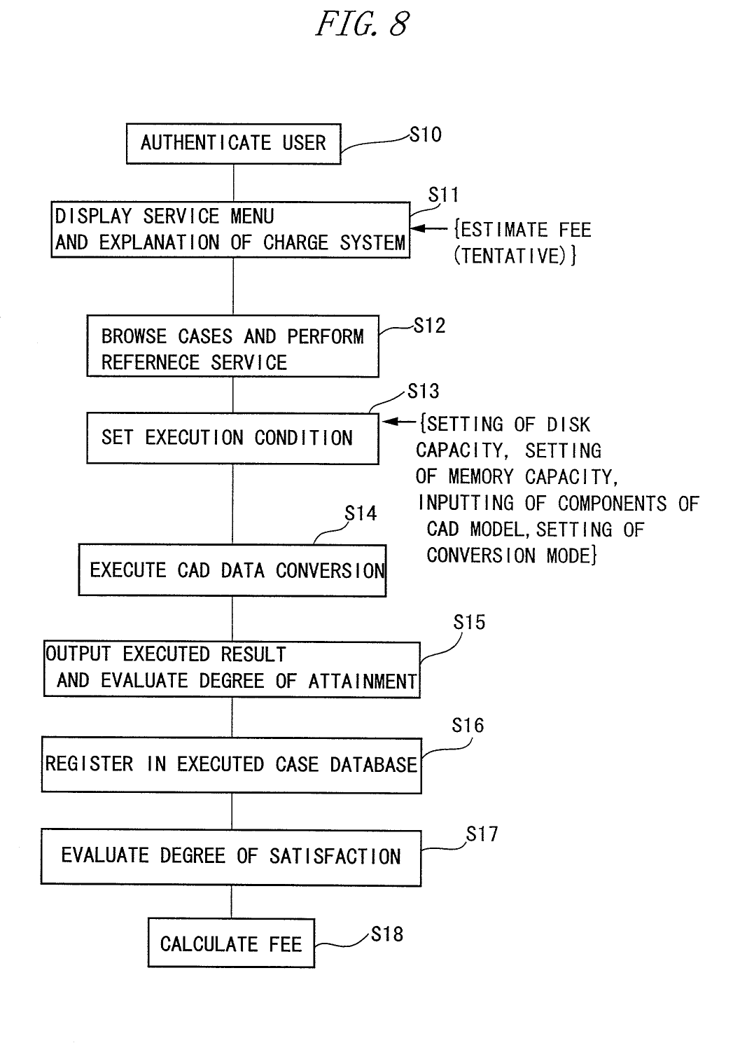

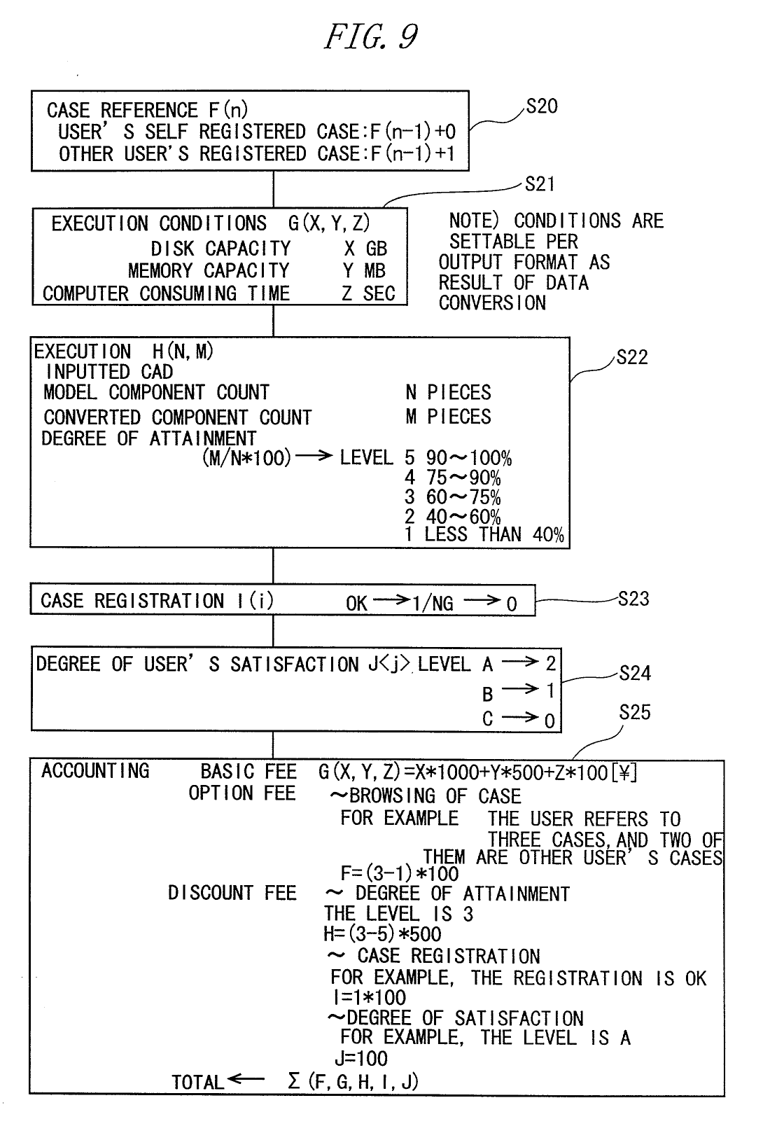

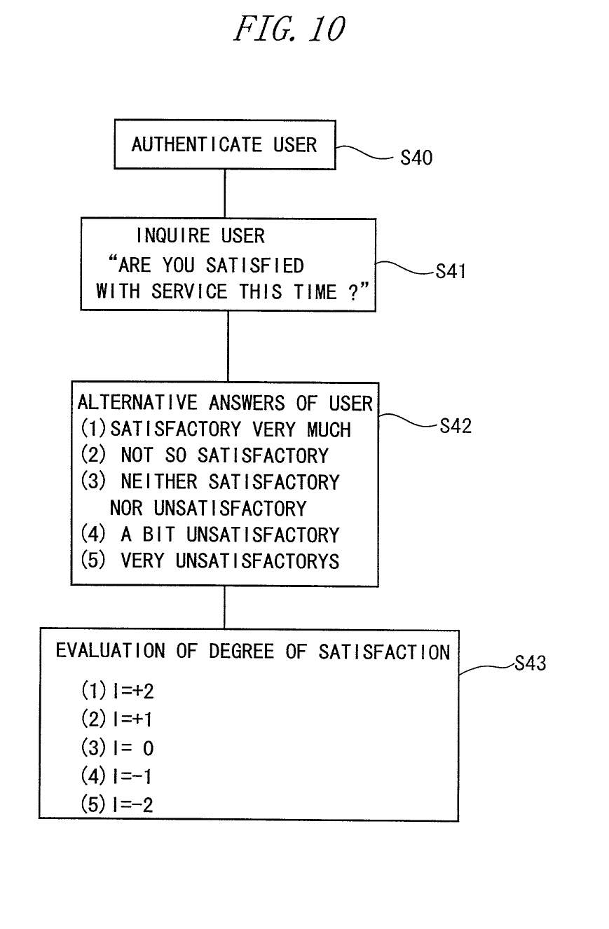

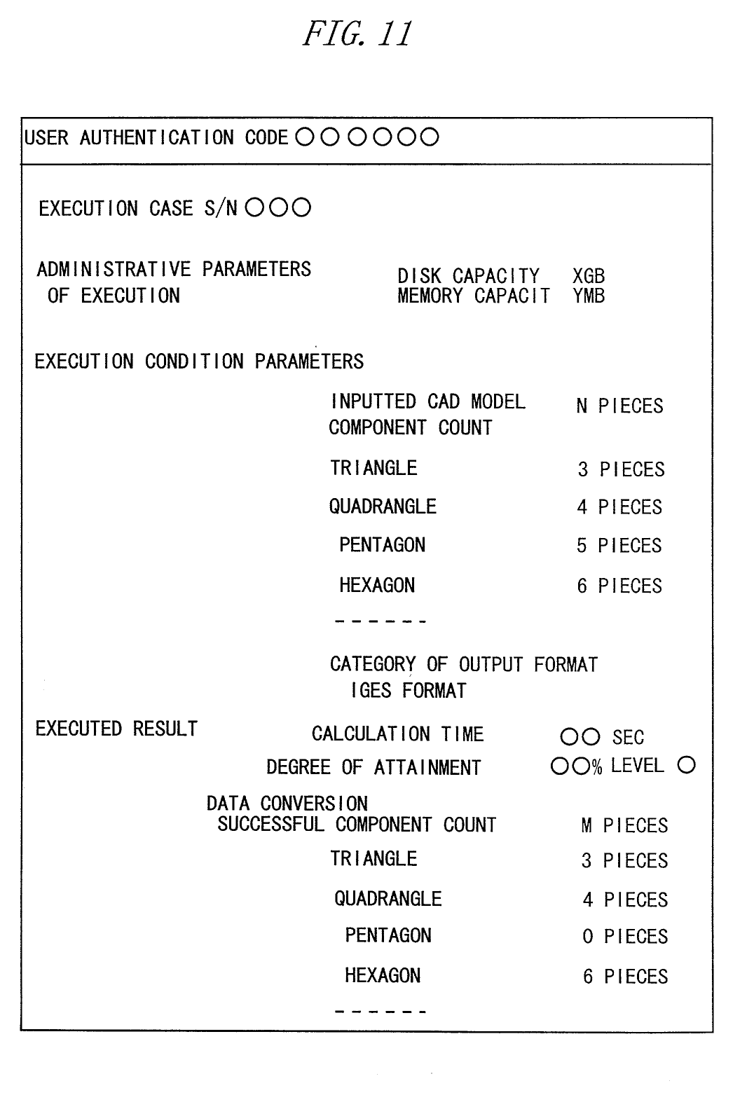

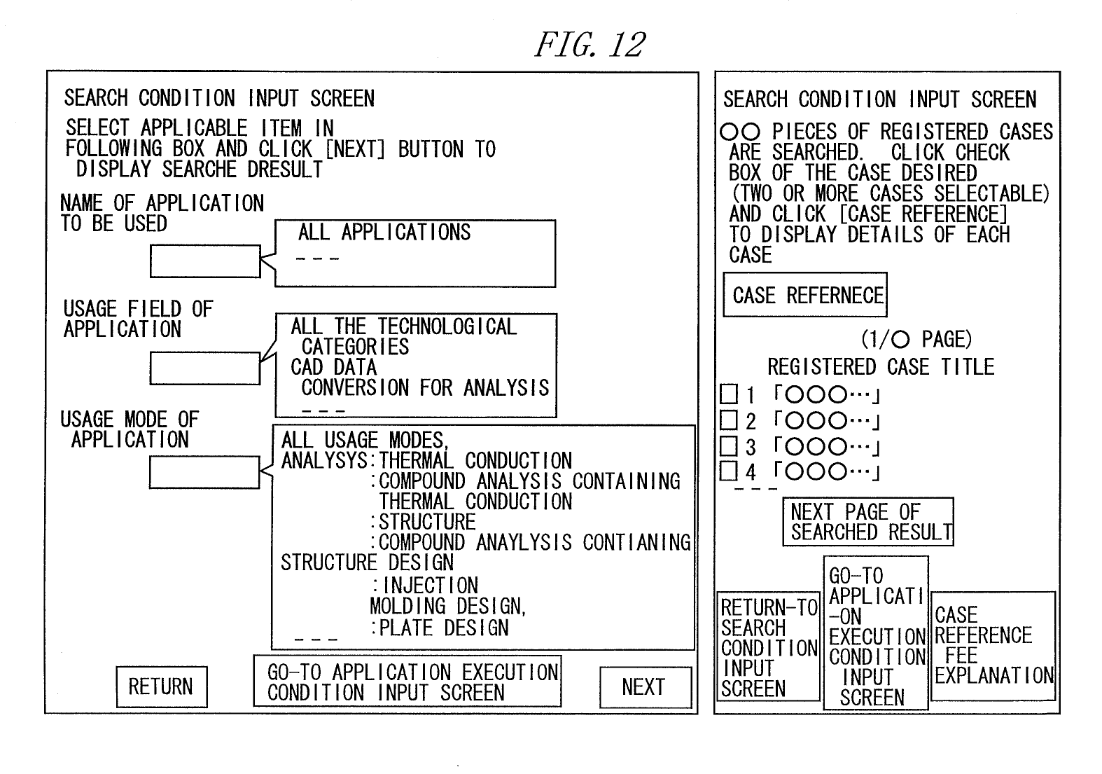

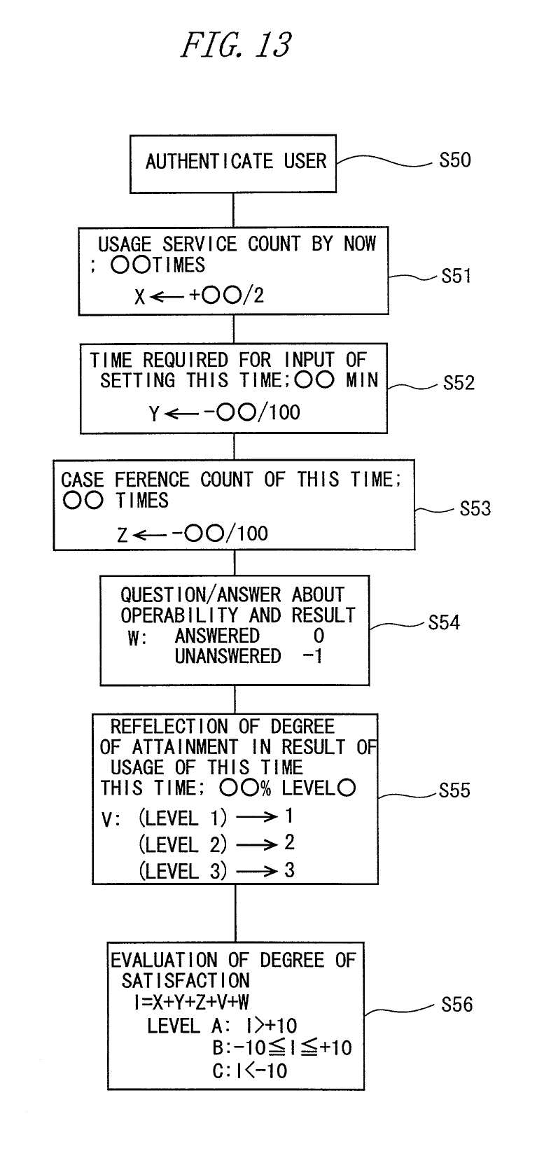

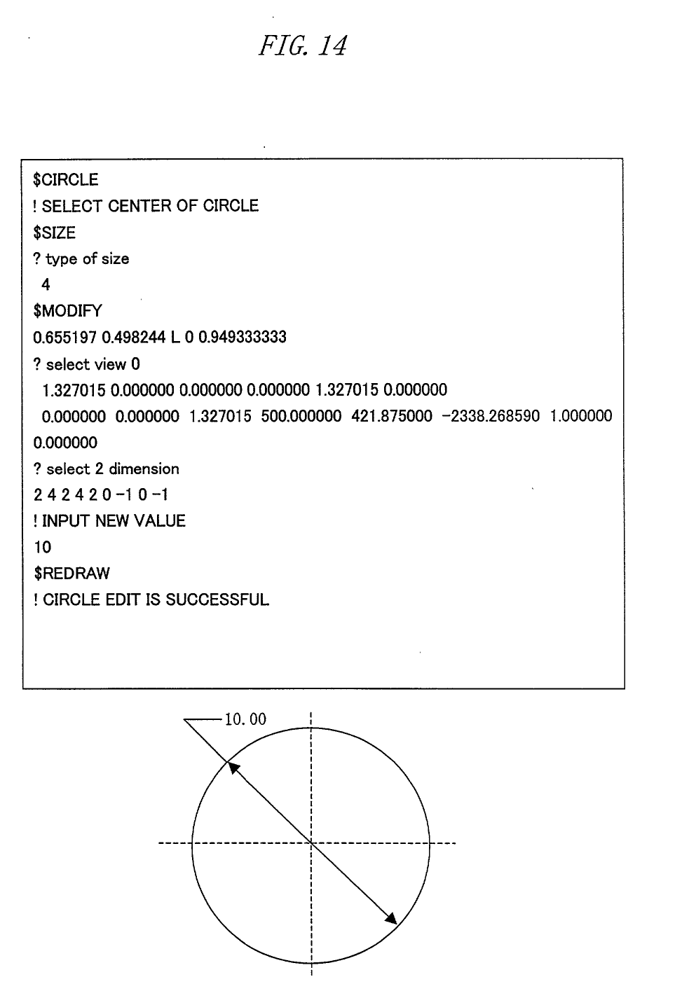

FIG. 1 is a diagram showing a basic architecture of an information processing system in the embodiment of the present invention. FIG. 2 is a diagram showing an example of a service/money flow in this information processing system. FIG. 3 is a diagram showing an example where a data conversion service is carried out in the information processing system shown in FIG. 1. FIG. 4 is a diagram showing a procedure of referring to cases of performing the data conversion service in FIG. 3. FIG. 5 is a diagram illustrating a hardware architecture of a server 1 shown in FIG. 1. FIG. 6 is a flowchart showing a processing flow of a CAD data conversion service on the side of a user terminal 11. FIG. 7 shows a display example of a charge system displayed on the user terminal 11 from the server 1. FIG. 8 is a flowchart showing a processing flow of the CAD data conversion service by the server 1. FIG. 9 is a chart showing a calculation flow of calculating a fee charged by the server 1. FIG. 10 shows an example 1 of a processing flow for evaluating a degree of satisfaction. FIG. 11 is a chart showing an executed case registration example in the user terminal 21. FIG. 12 is a chart showing a case search example in the user terminal 21. FIG. 13 is a flowchart showing an example 2 of the processing flow of evaluating the degree of satisfaction. FIG. 14 is a chart showing a macro command for drawing a circle as one of the executed cases.

### System Architecture

FIG. 1 is the diagram showing the basic architecture of the present information processing system. This information processing system is configured by connecting the server 1 and the user terminal 21 to each other via a network. The server 1 provides the user terminal 21 with a function of a service system for providing a variety of services.

For providing this service, the server 1 includes a database management module 11, a user management module 12 and an accounting control module 13. The server 1 will hereinafter be also referred to as a service system. Further, the user terminal 21 may be called a client.

The accounting control module 13, when providing each service, calculates a total charge consisting of a basic fee, a degree-of-attainment fee and a degree-of-satisfaction fee. Further, the accounting control module 13 calculates a license fee paid to a user who has registered a know-how as a case when using the service, and a refund corresponding to a degree of use by other user with respect to the registered case.

The user management module 12 executes a user registration/authentication process with respect to the user who uses the service. The user management module 12 provides an interactive processing function with the user via the user terminal 21. This interactive processing function includes, for instance, a function of selecting a type of the service, a function of presenting a charge system and a function of presenting a service charge.

Further, the user management module 12 receives a request from the user, provides the service requested, and evaluates a provided result.

The database management module 11 accepts a request for accessing the database, and executes an I/O process with respect to the database. A content of the service executed and various pieces of information in making use of the service, are registered as cases in this database.

FIG. 2 shows the example of the service/money flow in the present information processing system. For example, a user A accesses the database of the server 1 from a user terminal 21A.

The server 1 provides an application service in the database accessed. The server 1 charges the basic fee for the service provided. Moreover, the server 1 modifies the fee charged depending on the degree of satisfaction of the user and the degree of attainment of the service (e.g., a data conversion rate).

After a completion of the service, the content of the service and the various pieces of information in making use of the service are registered as application cases in the database. The server 1 pays a license fee for the registered case to the user A.

The user B accesses the database of the server 1 from a user terminal 21B. The server 1 provides the user B with the service as in the case of the user A, and calculates how much the user B is charged.

The user B does not, however, admit a registration of the case. Therefore, a content of the service for the user B is not registered as a case, and a license fee is not paid.

### Characteristic Functions of System

The present information processing system has the following characteristics.

### (1) Charge System

A charge imposed on a customer receiving the service consists of the basic fee, the fee based on the degree of attainment and the fee based on the degree of satisfaction.

Among these fees, the basic fee is determined by a physical using environment when receiving the service. This basic fee corresponds to a fee in a conventional charge-by-quantity system of an ASP. The basic fee is determined based on, for example, a computer using time, a capacity of a disk used, a fee for using a memory, and types and the number of applications used.

The degree-of-attainment fee is calculated corresponding to a degree of attainment of the service. The degree of attainment of the service is a rate at which the service is completely attained by the system of the service provider. For instance, in the case of the CAD data conversion service, the service rate is a rate of a successfully-converted component data count to an inputted component data count.

The degree-of-satisfaction fee is a fee determined corresponding to a degree of satisfaction answered by the customer with respect to a result of the service.

### (2) Used Case Registration System

The server 1 inquires the customer about whether or not the content of the service executed when requested by the customer and the various pieces of information when making use of the service may be disclosed. If the customer consents, the content of the service and the various pieces of information when using the service are registered in the case database.

The server 1 provides the customer concerned and other customers with a function of searching the registered cases. If a customer other than the customer having registered the case browses this case, a fee for using the case is paid to the customer who has registered the same case from the service provider.

This case using fee is periodically or unperiodically paid corresponding to a frequency at which other customer accesses that case. Further, after a fixed period has elapsed, if the frequency of accessing the case is small, this case is deleted from the case database.

This using fee may be paid batchwise to the customer having provided the case when registering the case instead of paying it depending on the access frequency. It may be confirmed on the occasion of obtaining a permission for the use whether the using fee depending on the access frequency or the batchwise payment is adopted.

### (3) Operation System

### (3-1) Selection of Charge System

The service charge system described in the item (1) can be operated by use of any one of the following fee combinations:

A: Basic Fee+Degree-of-Attainment Fee+Degree-of-Satisfaction fee

B: Basic Fee+Degree-of-Attainment Fee

C: Basic Fee+Degree-of-Satisfaction fee

Among the present ASP charge systems described above, the charge systems A and C each containing the degree-of-satisfaction fee may be operated as any one of an addition type and a subtraction type.

In the addition type, an initial value of the basic fee (plus the degree-of-attainment fee) is set to 100. Then, let a be a fee corresponding to the degree of satisfaction expressed by the customer, a using fee is given by 100+α.

In the subtraction type, an initial value of the basic fee (plus the degree-of-attainment fee) plus the degree-of-satisfaction fee is set to 100. Then, let β be a subtraction value corresponding to the degree of satisfaction expressed by the customer (β is a unsatisfactory degree in this case), a using fee is given such as 100−β.

A method of determining the degree of attainment is presented by the server to the customer corresponding to the content of the service. This method may be exemplified by a method based on a component modeling rate in a result of implementing the modeling service in, e.g., the CAD data conversion service.

The degree of satisfaction is determined by a subjective evaluation of the customer. Accordingly, the server 1 does not a physical measuring method. The degree of satisfaction is based on a system of being ranked depending on the subjectivity of the customer. The degree of satisfaction is recorded as a subjective evaluation such as “sufficiently satisfactory”, “satisfactory to some extent”, “unsatisfactory” and so on.

### (3-2) Used Case Registration System

The server 1 inquires the customer about whether or not the content of the service implemented by the customer may be used as a know-how case. If the customer permits, the content of the service and the various pieces of information when making use of the service are registered in the case database of the server 1 by the system described in the item (2). The information registered therein is provided as a case to other customers.

Whereas if the customer does not permit, the server 1 does not register the content of the service in the database. The above-mentioned agreement between the customer and the service provider is settled via the network.

### Outline of Processing

(1) The customer opens a homepage for providing the services and selects a specified service, e.g., the CAD data conversion service.

(2) The server 1 presents the charge system on a screen to the customer.

(3) The customer inputs the CAD data to an application program of the server 1 and executes the application program.

(4) The server 1 obtains a degree of attainment, e.g., a modeling success rate of the CAD data conversion in accordance with the executed result, and presents it to the customer.

(5) The customer specifies a degree of satisfaction on the screen for evaluating and inputting the degree of satisfaction.

(6) The server 1 calculates a total charge based on the result of what has been done so far, and presents the total charge to the customer.

(7) The customer, if desiring to provide the data of the customer himself or herself as a know-how case, permits the server 1 to use the same data. The server 1 settles how a use permission fee is paid to the customer, and thereafter finishes the service. If there is no intention to give the permission of the use, this procedure is skipped over, and the service comes to an end.

### Example of Providing Service

FIG. 3 shows an example of implementing the data conversion service in the information processing system illustrated in FIG. 1. From the user terminal 21, the user requests the server 1 for a certain service, e.g., the data conversion service by the application 101.

The server 1 executes the application 101 and reads a specified item of data from, e.g., a data interface 103 and outputs the data to output data 105. Herein, the data interface may be a category of a data format in the case of inputting the CAD data to the application program.

When the user approves the case registration, the content of this service, e.g., a type of the application executed, a type of the data interface used or a type of the output data, is outputted to the case database.

FIG. 4 shows an example of referring to the cases in the data conversion service. FIG. 4 shows an instance where, e.g., the user B requests the database of the server 1 for the data conversion service.

The user B, when making a request for the data conversion, refers to the data conversion cases that have been achieved in the past. For instance, what is referred to is such a case that the user A obtains output data Z at a high attainment rate by use of a data interface Y by an application X. The user B requests for the service with reference to a case among those cases that is similar to the process requested by the user B himself or herself.

### Hardware Architecture

FIG. 5 is the diagram showing the hardware architecture of the server 1. The server 1 includes a CPU 2 for executing the program, a memory 3 for storing the program executed by the CPU 2 and the data processed by the CPU 2, and a hard disk 4 for recording the program and the data. The server 1 further includes a display device 5 for displaying pieces of information of menus, icons, messages etc, a keyboard 6 for inputting the character data, a pointing device 7 for manipulating the menus and the icons on the display device 5, and a communication interface 8 for accessing the network.

The CPU 2 executes the program stored in the memory 3, thereby providing a function as the server 1.

The memory 3 is stored with the program executed by the CPU 2 and the data processed by the CPU 2.

The hard disk 4 records the program executed by the CPU 2 and the data processed by the CPU 2. Further, a variety of databases are structured on the hard disk 4.

The display device 5 displays the information inputted by an operator of the server 1 and the information of the menus, the icons and the messages. For example, a CRT, a liquid crystal display etc may be used as the display device 5.

The keyboard 6 is used for inputting the character data. The pointing device 7 is used for manipulating the menus and the icon displayed on the display device 5. What can be used as the pointing device 7 is, e.g., a mouse, a trackball, an electrostatic pointing device, a laser type pointing device, a touch panel etc.

The communication interface 8 accesses the network in accordance with a command given from the CPU 2, and communicates with the user terminals 21 on the network.

Each of the user terminals 21 has the same configuration as the server 1, and therefore its repetitive explanation is omitted. It is, however, desirable that the server 1 has a higher performance than the user terminal 21.

### Processing of User Terminal 21

FIG. 6 shows the processing flow on the side of the client, i.e., the user terminal 21 when making the request for the CAD data conversion service. In this process, to start with, the user terminal 21 displays a service menu of the server 1 on the display device (S1). A list of the services provided by the server 1 is displayed in the service menu.

Next, when the user specifies displaying the charge system, the user terminal 21 displays the charge systems of a variety of services (S2). At this time, the user may browse the cases by selecting a case reference menu. The user refers to the charge systems and the cases displayed on the user terminal 21, and examines conditions for executing the CAD data conversion.

Subsequently, the user terminal 21 executes an execution condition setting procedure in accordance with the user's operation (S3). In this procedure, the user sets resources such as disk capacity, a memory capacity etc which are used in the service on the screen of the user terminal 21.

Further, the user specifies a component expressed by a CAD model (a graphic expressed by the CAD data is called a model). Moreover, the user sets a converting method. The user terminal 21 reads and transmits the setting described above to the server 1.

Then, the server 1 reads the CAD data specified and executes CAD data conversion (S4). At this time, a result of the execution is evaluated, and a degree of attainment is recorded. The degree of attainment is calculated by the number of components with successful conversion among all the components in the CAD data specified.

Next, the user terminal 21 receives the executed result and the degree of attainment from the server 1, and displays them on the display device (S5).

Subsequently, the user terminal 21 executes a case registration procedure (S6). In this procedure, the user terminal 21 inquires the user about whether or not the content of the service implemented is registered as a case.

If the user approves the registration, this purport is transmitted to the server 1. The server 1 registers the content of the service implemented in the case database. Whereas if the user does not approve the case registration, the case is not registered.

Next, the user terminal 21 executes a degree-of-satisfaction check procedure (S7). In this procedure, the user terminal 21 displays a degree-of-satisfaction screen. The user terminal 21 transfers a piece of information indicating the degree of satisfaction inputted by the user to the server 1. The server 1 reflects this degree of satisfaction in calculation of a fee.

Subsequently, the user terminal 21 displays the fee transmitted from the server 1 (S8). The server 1 executes an accounting process based on this fee. All these procedures being done, the server 1 demands payment of the user from a predetermined bank account.

FIG. 7 shows an example of the charge system displays on the user terminal 21. As seen in this example, the charge consists of a CAD data conversion service basic fee, a CAD modeling fee, a case database fee and a degree-of-satisfaction fee based on the degree-of-satisfaction check.

The basic fee is calculated based on a disk capacity used, a memory capacity used and a computer consuming time (CPU consuming time).

The CAD data conversion fee differs depending on an output format after the conversion. A fee corresponding to a CAD model component count (the number of components) and a fee corresponding to a conversion success rate, are shown in each output mode. Before executing the conversion, however, a fee calculated on the assumption of the conversion success rate is shown.

The case database fee consists of a fee for browsing the case database, a fee discounted due to the registration, and a fee discounted due to such an achievement that other users have browsed the case of the user concerned.

The degree-of-satisfaction fee is set corresponding to the degree of satisfaction answered by the user. Further, when the user clicks on a tentative estimation button, an amount of tentative estimation is displayed.

### Processing of Server 1

FIG. 8 shows the processing flow of the CAD data conversion service by the server 1.

In this processing flow, at first, the server 1 executes an authentication of the user (S10). The user authentication requires the server 1 to confirm a user's ID and a password inputted from the user.

Next, the server 1 displays explanations of the service menu and the charge system on the user terminal 21 (S11). Further, the server 1 displays an estimation of the charge etc on the user terminal 21 in accordance with an indication given from the user.

Then, the server 1 browses the cases and implements a reference service (S12). In this process, the server 1 searches the cases in accordance with the indication given from the user, and displays the cases on the user terminal 21.

Next, the server 1 executes an execution condition setting process (S13). In this process, the server 1 receives settings of the disk capacity, the memory capacity etc. Further, the server 1 receives a specified target component of the data conversion expressed by the CAD model. Moreover, the server 1 receives a conversion mode set by the user.

Subsequently, the server 1 executes the CAD data conversion (S14). Next, the server 1 makes the user terminal 21 display a result of execution (S15). At this time, the server 1 simultaneously displays a degree of attainment of the data conversion on the user terminal 21.

Next, the server 1 executes an execution case database registration process (S16). In this process, if given a user's approval, the server 1 registers a content of executing the CAD data conversion in the case database.

Then, the server 1 executes a degree-of-satisfaction evaluation process (S17). In this process, the server 1 displays a degree-of-satisfaction input screen on the user terminal 21, and gets the degree of satisfaction inputted from the user. Next, the server 1 executes a fee calculation process (S18).

FIG. 9 shows an example of a processing flow of the fee calculation in the server 1. In this process, to start with, the server 1 calculates a reference count to the case database (S20). Even when the user refers to the case of the user himself or herself, the reference count is not incremented (which is shown such as F(n)=F(n−1)+0 in FIG. 9). While on the other hand, when other users have referred to the registered case, the number of references is counted (which is shown such as F (n)=F(n−1)+1 in FIG. 9, where F(i) is the reference count in providing the service n-th time).

Next, the server 1 records a quantity of the resources specified under the execution condition (S21). To be specific, the server 1 records a disk capacity X (GB), a memory capacity Y (MB) and a calculation time Z (sec).

Subsequently, the server 1 calculates an execution target data count and a degree of attainment (S22). Namely, to begin with, the server 1 obtains an inputted CAD model component count N and an actually converted component count M. Then, the server 1 obtains a degree-of-attainment M/N*100. The server 1 sorts out the degrees of attainment at five levels.

Next, the server 1 records a result (1 or 0) of whether or not the data conversion service is registered in the case database (S23). Subsequently, the server 1 gets the degrees of satisfaction (A, B, C) inputted (S24).

Next, the server 1, based on the records described above, calculates the fee (S25). At first, the basic fee G is calculated according to the disk capacity X (GB), the memory capacity Y (MB) and the calculation time Z (sec) in the following formula:

G (X, Y, Z)=X*1000+Y*100+Z*100

Further, a fee (option fee) F based on the case reference is calculated in, for instance, the following formula:

F=Other User Case Reference Count *100

Moreover, a discounted fee H based on the degree of attainment is calculated in, for example, the following formula:

H=(Data Conversion Degree-of-Attainment Level−Maximum Degree-of-Attainment Level) *500

where the data conversion degree-of-attainment level is one of the five levels given in S22.

Further, a discounted fee I in the case of approving the case registration is given in the following formula:

I=−1*100

where 1 represents an approval of the case registration (if not approved, 0 is given).

Furthermore, a fee J based on the degree of satisfaction of the user is given as follows on the assumption of the degree of satisfaction is, e.g., a level A. This fee based on the degree of satisfaction may be set referring to a table stored with information on a relation between degree of satisfaction and fee may be set referring to a table.

J=100

The fee calculation is completed by totaling the respective fees give above.

### Evaluation of Degree of Satisfaction

FIG.10 shows an example 1 of a processing flow of evaluating the degree of satisfaction. In the example 1, the degree-of-satisfaction evaluation process is executed by the user's inputting an impression the user has about the service.

In this process, at first, the server 1 executes the user authentication (S40). The user authentication executed herein is a process of ensuring a user's degree-of-satisfaction recording area in which to input an evaluation of the degree of satisfaction.

Next, the server 1 questions the user on the display such as “Are you satisfied with the service of this time ?” (S41). Then, the server 1 displays alternative answers as indicated in S42 on the user terminal 21 to prompt the user to select the answer (S42). Next, the server 1 records the degree of satisfaction corresponding to the user's selection (S43).

### Case Registration Process

FIG. 11 shows an example of registering the execution cases in the case database. A record in the case database contains a user authentication code, a execution case serial number (which is indicated by S/N in FIG. 11), administrative parameters of execution, execution condition parameters, and executed results.

The user authentication code is a code for identifying a client for requesting the server to execute the case concerned. The administrative parameters of execution are, e.g., the disk capacity, the memory capacity and so on.

The execution condition parameters are the inputted CAD model component count etc and may include setting of a type of the output format. Of these items of data, the inputted CAD model component count field is recorded with a total number of components, categories thereof, and the number of each of the categories such as a triangle, a quadrangle, a pentagon, a hexagon etc.

Further, the executed results include the calculation time, the degree of attainment and the number of components (the total number and categories) with the successful data conversion.

### Case Search Process

FIG. 12 shows an example of searching the case from the user terminal 21 defined as a client. FIG. 12 shows a search condition input screen and a searched result display screen.

The search condition input screen displays an application name input box of an application to be used (labeled with “NAME OF APPLICATION TO BE USED”), a usage field input box of the application (labeled with “USAGE FIELD OF APPLICATION”), a usage mode input box of the application (labeled with “USAGE MODE OF APPLICATION”), a “Return” button, a “Go-to application execution condition input screen” button, and a “Next” button.

For example, “All applications” or a name of a specified application is inputted to the application name input box.

“All the technological categories” or “CAD data conversion for analysis” etc is inputted to the usage field input box of the application. “All usage modes”, “Analysis: thermal conduction” or “Design: injection mold design” etc is inputted to the usage mode input box of the application.

With respect to these settings, when the user presses the “Next” button by use of the pointing device 7, a search for the case database is executed. Further, the user presses the “Go-to application execution condition input screen” button, and further inputs an application execution condition, whereby the searching target can be narrowed down. Moreover, when the user presses the “Return” button, the contents on the search condition input screen are cleared, and an unillustrated main screen is displayed.

The searched result display screen displays a “Case reference” button, a registered case title list, “Next page of searched result” button, a “Return-to search condition input screen” button, a “Go-to application execution condition input screen” button, and a “Case reference fee explanation” button.

Titles of the registered cases are displayed together with check boxes for inputting check marks in the field of the registered case title list. The user inputs a check mark corresponding to a title of the registered case the user desires to refer to, using the pointing device 7, and presses the “Case reference” button, the case checked is displayed.

When “Next page of searched result” button is pressed, a next page in the registered case tile list is displayed. Further, when the “Return-to search condition input screen” is pressed, the display returns to the left screen in FIG. 12. Moreover, when each of the “Go-to application execution condition input screen” button and the “Case reference fee explanation” button is pressed, each of the screens is displayed.

As discussed above, in the service executed by the server 1 in this embodiment, the degree of attainment of the service reflects in the fee for the use. As a result, the service exhibiting a higher degree of attainment with respect to the request by the user costs a larger amount of usage fee. By contrast, the service exhibiting a lower degree of attainment costs a smaller amount of usage fee. Therefore, the service usage fee is well balanced with the achievement obtained by the user.

Moreover, in the service executed by the server 1 in this embodiment, the degree of satisfaction of the user with respect to the service reflects in the fee for the use. As a result, a conviction of the user about the usage fee is easy to obtain.

Furthermore, in the embodiment discussed above, the contents of the services used by the users are registered in the case database. Consequently, the customers can share the know-how of using the services. The service contents are registered when the user approves the registration. Further, upon the registration, a license fee is paid to the user who approved. Moreover, the user having referred to the case pays a fee corresponding to how much the case has been referred to. Thus, according to the present invention, a value can be added to what has hitherto been hard to give a right as an intellectual property right like the know-how of using the service in the ASP etc.

This kind of know-how sharing is effective especially in such an application that the achievement becomes larger depending on how the usage conditions are set, e.g., in the service such as the CAD data conversion etc.

Further, the user is requested to approve the registration of the know-how as described above, whereby the limited items of information that may be disclosed to other users can be disclosed to those users. As a result, it is feasible to flexibly operate the system designed to exchange the know-how between the users.

### Modified Example of Processing Flow of Evaluating Degree of Satisfaction

In accordance with the embodiment discussed above, the evaluation of the degree of satisfaction is executed by the user's inputting the impression the user has as shown in FIG. 10. The embodiment of the present invention is not, however, limited to the procedure described above. The degree of satisfaction may be evaluated by, for instance, a procedure shown in FIG. 13.

Referring to FIG. 13, the degree of satisfaction is evaluated based on a behavior of the user. In this degree-of-satisfaction evaluation process, to begin with, the server 1 authenticates the user, and ensures a degree-of-satisfaction evaluated result storage area on the memory (S50).

Next, a service usage count of the service used so far by the authenticated user reflects in an evaluation using a parameter X (S51). It may be considered that the user is more satisfactory about the service as this service usage count is larger.

Next, the server 1 reflects a time required for inputting the setting this time as a negative numerical value in an evaluation using a parameter Y (S52). It may be considered that the user feels the interface being less user-friendly as the setting input time becomes longer.

Next, the server 1 reflects the case reference count of this time in an evaluation using a parameter Z (S53). It may be conceived that the user obtains more effective pieces of information as the case reference count increases.

Subsequently, the server 1 judges whether or not the user has answered a question about an operability and a result, and reflects it in an evaluation using a parameter W (S54). If answering the above question, it may be considered that the user has a good impression about the service.

Next, the server 1 reflects the degree-of-attainment level in the service of this time in an evaluation using a parameter V (S55). It may be conceived that the degree of satisfaction of the user is higher as the degree-of-attainment level is higher.

Next, the server 1 adds the evaluations using the parameters X through W described above, and thus evaluates a degree-of-satisfaction level (S56). This evaluation is given in such a way that “if the added result is larger than a predetermined value, the degree-of-satisfaction is set to A”.

As described above, the degree of satisfaction of the user is judged from the behavior of the user, thereby making it possible to subjectively evaluate the degree of satisfaction of the user. As a result, it is feasible to avoid such a trouble that the user, even though satisfied with the service, intentionally answers that the service is unsatisfactory in order to reduce the fee.

### Other Modified Examples

In the embodiment discussed above, the fee to be imposed is calculated based on the degree of attainment of the service. The embodiment of the present invention is not, however, restricted to the procedure described above. For example, the fee may be calculated based on a performance and a quality of the application program provided by the ASP. According to a service for outputting, e.g., an executive image of a specified computer by compiling the program, a fee may be calculated corresponding to a compile time, a degree of optimization of the compile executive image and a processing speed in the executive image itself.

This may involve performing a benchmark test for every compiler and evaluating a plurality of compilers beforehand or periodically. This procedure is not confined to the compiler and can be applied to a general type of application programs for generating the data.

In the embodiment discussed above, the results of using the service, e.g., the data conversion execution environment, the data conversion execution condition and the executed result, are registered in the case database. The embodiment of the present invention is not, however, limited to the above architecture and procedure.

For instance, the component data (model data), which have already been created by the CAD data, may be registered as a CAD data library in the case database. The registration of this data library can lead to an omission of time-consuming processes in design with respect to the common components between the users.

Further, for example, a macro command with combinations of the functions provided by the CAD may also be registered in the case database. This type of registration can also omit the time-consuming processes of repetitively creating the macro commands that can be used in common between the users.

FIG. 14 shows an example of the macro command. FIG. 14 shows an example of executing the macro command for creating, modifying and displaying a circle. This macro command is a combination of a command ($CIRCLE) for starting a definition of the circle, a command ($SIZE) for specifying a size of the circle, a command ($MODIFY) for modifying the size of the circle, and a command ($REDRAW) for redrawing the circle. The user is able to draw the circle having a desired size in a desired position on the screen by executing the macro command.

The user individually creates and uses the macro command described above in a variety of application programs. In the information processing system demonstrated in this embodiment, the user can share the variety of know-how containing those macro commands. As a result, the operations, which are repetitively performed between the users, are made more efficient. Further, a license fee for registering the macro command and a usage fee for using the macro command are paid, and an added value is thus given.

### Readable-by-Computer Recording Medium

The program for actualizing any one of the functions of the information processing system in the embodiment discussed above, maybe recorded on a readable-by-computer recording medium. Then, the computer reads the program from this recording medium and executes the same program, thereby functioning as the server 1 exemplified in the embodiment discussed above.

Herein, the readable-by-computer recording medium embraces recording mediums capable of storing information such as data, programs, etc electrically, magnetically, optically and mechanically or by chemical action, which can be all read by the computer. What is demountable out of the computer among those recording mediums may be, e.g., a floppy disk, a magneto-optic disk, a CD-ROM, a CD-R/W, a DVD, a DAT, an 8 mm tape, a memory card, etc.

Further, a hard disk, a ROM (Read Only Memory) and so on are classified as fixed type recording mediums within the computer.

### Data Communication Signal Embodied in Carrier Wave

Furthermore, the above program may be stored in the hard disk and the memory of the computer, and downloaded to other computers via communication media. In this case, the program is transmitted as data communication signals embodied in carrier waves via the communication media. Then, the computer downloaded with this program can be made to function as the server 1 in the embodiment discussed above.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broad band signal and an unmodulated base band signal (corresponding to a case of setting a DC signal having a voltage of 0 as a carrier wave).

What is claimed is:

1. A server device comprising:
a communication module performing communications with a client device;
a service providing module providing a service to said client device via said communication module;
an evaluation module evaluating a quality of the service provided; and
a fee calculation module calculating a fee charged for the service in a way that reflects a result of the evaluation in the calculation.

2. A server device according to claim 1, wherein said evaluation module evaluates the quality of the service on the basis of a degree of attainment of the service requested from said client device.

3. A server device according to claim 1, wherein said communication module receives information on a degree of satisfaction of a customer which is evaluated by said client device with respect to the service provided, and
said evaluation module evaluates the quality of the service on the basis of the degree of satisfaction of the customer.

4. A server device according to claim 1, further comprising:
a recording module recording a history of accesses to said server device from said client device; and
a count module counting a setting operation time when making a request for the service via said client device,
wherein said evaluation module estimates a degree of satisfaction of the customer with respect to the service from the history of the accesses, the setting operation time counted or the degree of attainment of the service in response to the request given from said client device.

5. A server device comprising:
a communication module performing communications with a client device;
a service providing module providing a service to said client device via said communication module; and
a usage knowledge accumulation module accumulating pieces of usage knowledge for using the service, wherein said service providing module, when completing the service for said client device, makes a request for an approval for accumulating pieces of information on the service as the usage knowledge in said usage knowledge accumulation module, and
said usage knowledge accumulation module, if obtaining the approval from said client device, accumulates the information on the service, and provides said client device or other client device with the information.

6. A server device according to claim 5, further comprising a fee calculation module calculating a fee charged for the service provided,
wherein said fee calculation module discounts the fee charged for the service when obtaining the approval.

7. A server device according to claim 5, wherein the information on the service is information on an execution case of executing an application program provided in the service, information on a definition of a macro process consisting of a combination of a plurality of functions provided in the application program, or data generated by executing the application program.

8. A service providing method of providing a service to a client device connected to a network, comprising:
receiving a request from said client device;
providing the service corresponding to the request;
evaluating a quality of the service provided; and
calculating a fee charged for the service in a way that reflects a result of the evaluation in the calculation.

9. A service providing method according to claim 8, further comprising calculating a degree of attainment of the service provided in response to the request given from said client device,
wherein the quality of the service is evaluated based on the degree of attainment in said evaluation.

10. A service providing method according to claim 8, further comprising a step of receiving information on a degree of satisfaction of a customer which is evaluated by said client device with respect to the service provided,
wherein the quality of the service is evaluated based on the degree of satisfaction of the customer in said evaluation step.

11. A service providing method according to claim 8, further comprising:
recording a history of accesses to said server device from said client device;
counting a setting operation time when making a request for the service via said client device; and
calculating a degree of attainment of the service provided in response to the request given from said client device,
wherein a degree of satisfaction of the customer with respect to the service is estimated from the history of the accesses, the setting operation time or the degree of attainment of the service in response to the request given from said client device, and a quality of service is evaluated base on the degree of satisfaction of the customer in said evaluation.

12. A service providing method of providing a service to a client device connected to a network, comprising:
receiving a request from said client device;
providing the service corresponding to the request;
evaluating a quality of the service provided;
making a request for an approval for accumulating pieces of information on the service as usage knowledge when completing the service for said client device;
accumulating the information on the service as the usage knowledge if obtaining the approval from said client device; and
providing said client device or other client device with the information on the service.

13. A service providing method according to claim 12, wherein the fee charged for the service is discounted when obtaining the approval in said fee calculation.

14. A service providing method according to claim 12, wherein the usage knowledge is information on an execution case of executing an application program provided in the service, information on a definition of a macro process having a combination of a plurality of functions provided in the application program, or data generated by executing the application program.

15. A readable-by-computer recording medium recorded with a program, for providing a service to a client device connected to a network, executed by a computer, said program comprising:
receiving a request from said client device;
providing the service corresponding to the request;
evaluating a quality of the service provided; and
calculating a fee charged for the service in a way that reflects a result of the evaluation in the calculation.

16. A readable-by-computer recording medium recorded with a program according to claim 15, further comprising calculating a degree of attainment of the service provided in response to the request given from said client device,
wherein the quality of the service is evaluated based on the degree of attainment in said evaluation.

17. A readable-by-computer recording medium recorded with a program according to claim 15, further comprising receiving information on a degree of satisfaction of a customer which is evaluated by said client device with respect to the service provided,
wherein the quality of the service is evaluated based on the degree of satisfaction of the customer in said evaluation.

18. A readable-by-computer recording medium recorded with a program according to claim 15, further comprising:
recording a history of accesses to said server device from said client device;
counting a setting operation time when making a request for the service via said client device; and
calculating a degree of attainment of the service provided in response to the request given from said client device,
wherein a degree of satisfaction of the customer with respect to the service is estimated from the history of the accesses, the setting operation time or the degree of attainment of the service in response to the request given from said client device, and a quality of service is evaluated base on the degree of satisfaction of the customer in said evaluation.

19. A readable-by-computer recording medium recorded with a program, for providing a service to a client device connected to a network, executed by a computer, said program comprising:
receiving a request from said client device;
providing the service corresponding to the request;
evaluating a quality of the service provided;
making a request for an approval for accumulating pieces of information on the service as usage knowledge when completing the service for said client device;
accumulating the information on the service as the usage knowledge if obtaining the approval from said client device; and
providing said client device or other client device with the information on the service.

20. A readable-by-computer recording medium recorded with a program according to claim 19, wherein the fee charged for the service is discounted when obtaining the approval in said fee calculation.

21. A readable-by-computer recording medium recorded with a program according to claim 19, wherein the usage knowledge is information on an execution case of executing an application program provided in the service, information on a definition of a macro process consisting of a combination of a plurality of functions provided in the application program, or data generated by executing the application program.
